(19) United States
(12) Patent Application Publication
(10) Pub. No.: US 2026/0103578 A1
(43) Pub. Date: Apr. 16, 2026

(54) METHOD TO PRODUCE FROTH FOAM

(71) Applicant: THE CHEMOURS COMPANY FC, LLC, Wilmington, DE (US)

(72) Inventors: JEFFREY B. SOWDER, CLAYTON, DE (US); Andrew J. BLEMINGS, CLAYTON, DE (US); Ernest Byron WYSONG, Chadds Ford, PA (US); Konstantinos KONTOMARIS, Wilmington, DE (US)

(21) Appl. No.: 19/115,304

(22) PCT Filed: Sep. 29, 2023
(86) PCT No.: PCT/US2023/034079

§ 371 Date: Mar. 26, 2025

Related U.S. Application Data
(60) Provisional application No. 63/411,878, filed on Sep. 30, 2022.

(51) Int. Cl. C08J 9/14; C08J 9/12; C08J 9/228

(52) U.S. Cl. CPC C08J 9/146; C08J 9/122; C08J 9/127; C08J 9/228; C08J 2201/022; C08J 2203/06; C08J 2203/142; C08J 2203/162; C08J 2203/182; C08J 2203/202; C08J 2207/04; C08J 2375/04

(57) ABSTRACT

The present disclosure provides a method to produce a froth polyurethane foam using storage stable components. The method comprises preparing an A component, which comprises an isocyanate; preparing a B component, which comprises an isocyanate-reactive compound, and generating a foam by mixing the A component and the B component at a low pressure; wherein the A component or the B component or both further comprise a blowing agent comprising E-1,1,1,4,4,4-hexafluoro-2-butene (E-HFO-1336mzz) and one or more of a co-blowing agent chosen from carbon dioxide, nitrogen, or 1,1-difluoroethane (HFC-152a).

### CROSS REFERENCE TO RELATED APPLICATIONS

This application claims the benefit of priority of U.S. Provisional Application No. 63/411,878 filed Sep. 30, 2022, the disclosures of which are incorporated herein by reference in its entirety.

### FIELD

Compositions and methods for frothing polyurethane (PUR) or polyisocyanurate (PIR) using low pressure equipment are disclosed. In one aspect the invention is a low-pressure method of frothing polyurethane or polyisocyanurate using a low global warming potential (GWP) blowing agent comprising E-1,1,1,4,4,4-hexafluoro-2-butene (E-HFO-1336mzz) while in another aspect, the invention relates to a froth foam kit using the low GWP blowing agent.

### BACKGROUND

For polyurethane or polyisocyanurate foam applications, foamable compositions are provided in two component formulations, an A component (which contains isocyanate) and a B component (which contains an isocyanate-reactive compound such as a polyol).

Certain applications such as froth kit foams require the use of a gaseous blowing agent incorporated in both the A component and the B component to enhance the frothiness of the mixture of the A and B components and to enhance mixing of the components in low pressure mixing equipment. The reactive components are each stored in separate containers under pressure, with additional ingredients in each container to support producing the foam, such as catalyst, water, inert gas, etc. The two components are then mixed to produce a froth foam, which is discharged through an applicator nozzle. Following discharge, the froth foam, which is a polyurethane stream, can be sprayed to a target to provide sealing and insulation.

Historically, blowing agents have included hydrochlorofluorocarbons such as HCFC-22 (chlorodifluoromethane) and hydrofluorocarbons such as HFC-134a (1,1,1,2-tetrafluoroethane). These blowing agents (HCFC-22 and HFC-134a) have a high global warming potential (GWP).

Low GWP compounds such as E-1,3,3,3-tetrafluoropropene (E-HFO-1234ze) and E-1-chloro-3,3,3-trifluoropropene (E-HFO-1233zd) have been suggested for use in as blowing agents in polyurethane froth foams having a boiling point and properties that are suitable. However, certain low GWP blowing agents have been found to deteriorate in foamable compositions over time. For example, E-HFO-1234ze is known to break down yielding HF when used in the presence of amine catalysts used to produce foams and E-HFO-1233zd is susceptible to decomposition to corrosive chlorine compounds, including HCl. Notwithstanding safety concerns, the presence of HF or HCl in a blowing agent significantly reduces foam reactivity and quality, while prolonging curing time.

Thus there is a need for new blowing agent formulations and compositions for froth foam kits as well as methods for producing froth foams.

### SUMMARY

The present invention provides a method to meet the need for low global warming potential (GWP) and zero ozone depleting potential (ODP) sustainable blowing agents, particularly for low pressure spray polyurethane or polyisocyanurate foam.

The present invention provides a method for the generation of a foam comprising: (a) preparing an A component, which comprises an isocyanate; (b) preparing a B component, which comprises an isocyanate-reactive compound, and (c) generating a foam by mixing the A component and the B component at low pressure; wherein the A component or the B component or both further comprise a blowing agent comprising E-1,1,1,4,4,4-hexafluoro-2-butene (E-HFO-1336mzz) and one or more of a co-blowing agent chosen from carbon dioxide, nitrogen, or 1,1-difluoroethane (HFC-152a); and wherein the low pressure is at least about 50 psi and up to about 500 psi (at least about 0.34 up to about 3.4 MPa).

In one embodiment the A component comprises a blowing agent which comprises E-1,3,3,3-tetrafluoropropene (E-HFO-1234ze) and the B component comprises a blowing agent which comprises E-HFO-1336mzz. In this embodiment, the A component and the B component are provided in separate pressurized cylinders and the amount of blowing agent added to each cylinder is sufficient to equalize pressure in both cylinders.

In some embodiments, one or more isomers of butane and/or pentane is added to the A component or the B component. Butane isomer is preferably isobutane. Isomers of pentane include n-pentane, isopentane and cyclopentane.

In some embodiments, methyl formate or water is added to the A component or the B component, or both.

The present invention provides a polyurethane froth foam kit comprising: (a) a cylinder comprising an A component, which comprises an isocyanate; (b) a cylinder comprising a B component, which comprises an isocyanate-reactive compound; and (c) a low pressure mixer having a mixing chamber and a spray nozzle, wherein E-1,1,1,4,4,4-hexafluoro-2-butene (E-HFO-1336mzz) and one or more of a co-blowing agent chosen from carbon dioxide, nitrogen, or 1,1-difluoroethane (HFC-152a) are added to the A component, the B component, or both.

The present disclosure also provides a polyurethane or polyisocyanurate foam prepared by the methods disclosed herein. The present disclosure also provides a polyurethane or polyisocyanurate foam prepared using the polyurethane froth foam kit as disclosed herein.

The present disclosure provides a foamable composition. The combination of the A component and the B component is referred to herein as a “foamable composition”. The foamable composition comprises: (a) a blowing agent comprising E-1,1,1,4,4,4-hexafluoro-2-butene (E-HFO-1336mzz); (b) one or more of a co-blowing agent chosen from carbon dioxide, nitrogen, or 1,1-difluoroethane (HFC-152a); (c) an isocyanate; (d) a polyol; (e) a catalyst; and (f) a surfactant.

### DESCRIPTION

Unless stated to the contrary, all parts and percents are based on weights.

The present disclosure provides a method for the generation of a foam comprising: (a) preparing an A component, which comprises an isocyanate; (b) preparing a B component, which comprises an isocyanate-reactive compound, and (c) generating a foam by mixing the A component and the B component at a low pressure; wherein the A component or the B component or both further comprise a blowing agent comprising E-1,1,1,4,4,4-hexafluoro-2-butene (E-HFO-1336mzz) and one or more of a co-blowing agent chosen from carbon dioxide, nitrogen, or 1,1-difluoroethane (HFC-152a); and wherein the low pressure is at least about 50 psi and up to about 500 psi (at least about 0.34 up to about 3.4 MPa). The pressure is preferably at least 100 psi, more preferably at least 150 psi and most preferably at least 200 psi.

In some embodiments, the amount of E-HFO-1336mzz added to the B component is between about 0% and about 20% by weight of the B component. The amount E-HFO-1336mzz added to the B component can be for example, about 5% to about 20%, about 5% to about 15%, about 5% to about 10%, or about 10% to about 15%.

For clarity, if the amount of E-HFO-1336mzz added to the B component is 0%, then the A component must comprise E-HFO-1336mzz. The amount of E-HFO-1336mzz added to the A component is between about 0% and about 15% by weight of the A component. The amount E-HFO-1336mzz added to the A component can be for example, about 5% to about 15%, or about 5% to about 10%.

One embodiment of the present disclosure is a polyurethane froth foam kit comprising: (a) a cylinder comprising an A component, which comprises an isocyanate; (b) a cylinder comprising a B component, which comprises an isocyanate-reactive compound; and (c) a low pressure mixer having a mixing chamber and a spray nozzle, wherein the A component, the B component, or both comprise E-1,1,1,4,4,4-hexafluoro-2-butene (E-HFO-1336mzz) and one or more of a co-blowing agent chosen from carbon dioxide, nitrogen, or 1,1-difluoroethane (HFC-152a); and wherein the A component and the B component are provided in separate pressurized cylinders.

Note, “froth foam kit” is synonymous and is used interchangeably herein with “polyurethane froth foam kit”.

By a “low pressure mixer” is meant herein as any mixer capable of mixing the A component and B component at pressures of 50 psi and up to about 500 psi (0.34 to 3.4 MPa).

In one embodiment of the polyurethane froth foam kit as provided herein, the amount of blowing agent added to each cylinder is sufficient to equalize pressure in both cylinders. By each cylinder is understood to refer to the cylinder containing the A component and the cylinder containing the B component.

The present disclosure further provides a polyurethane or polyisocyanurate foam prepared by the method of disclosed herein or using the froth foam kit as disclosed herein. In one embodiment, the polyurethane foam provided herein has an R-value of greater than 6 and a closed cell content of greater than 80% or greater than 90%.

In one embodiment, the foam according to the present disclosure has a density in the range of 1.8 to 2.5, preferably 1.9 to 2.1 pounds per cubic foot or pcf (28.8 to 40.0, preferably 30.4 to 33.6 kilograms per cubic meter or kg/m³).

In one embodiment, in performing the method for generation of a foam disclosed herein, the low pressure is from about 100 psi and up to about 400 psi (from about 0.69 MPa and up to about 2.76 MPa) or from about 150 psi to about 300 psi (from about 1.03 MPa to about 2.07 MPa). In one embodiment, the low pressure is at least 100 psi (0.69 MPa) up to 500 psi (3.4 MPa), or at least 150 psi (1.03 MPa) up to 500 psi (3.4 MPa) or at least 200 psi (1.38 MPa) up to 500 psi (3.4 MPa).

In one embodiment of the present method or froth foam kit, the A component and the B component are provided in separate pressurized cylinders and the amount of co-blowing agent added to each cylinder is sufficient to equalize pressure in both cylinders. For example, in the present method prior to mixing the A component and the B component, both cylinders may be pressurized with a co-blowing agent such as nitrogen to a pressure is at least about 50 psi and up to about 500 psi, such as (at least about 0.34 MPa up to about 3.4 MPa). The pressure may be at least 100 psi (0.69 MPa), or at least 150 psi (1.03 MPa) or at least 200 psi (1.38 MPa).

One embodiment of the present disclosure is a foamable composition. By a “foamable composition” is meant the combination of the A component and the B component. The foamable composition of the present disclosure comprises: (a) a blowing agent comprising E-1,1,1,4,4,4-hexafluoro-2-butene (E-HFO-1336mzz), (b) one or more of a co-blowing agent chosen from carbon dioxide, nitrogen, or 1,1-difluoroethane (HFC-152a); (c) an isocyanate; (d) a polyol; (e) a catalyst; and (f) a surfactant.

In one embodiment of the method or the froth foam kit or the foam, prepared by the method or using the froth foam kit disclosed herein, the A component comprises a blowing agent which comprises E-1,3,3,3-tetrafluoropropene (E-HFO-1234ze) and the B component comprises a blowing agent which comprises E-HFO-1336mzz. In the method or froth foam kit of this embodiment, the A component and the B component are provided in separate pressurized cylinders and the amount of blowing agent added to each cylinder is sufficient to equalize pressure in both cylinders. In one method or froth foam kit of this embodiment, the A component and the B component are provided in separate pressurized cylinders and one or both cylinders are pressurized with a co-blowing agent to achieve a pressure of at least 50 psi (0.34 MPa). The co-blowing agent may be nitrogen.

In one embodiment of the method or the froth foam kit or the foam according to this disclosure, the A component or the B component or both comprise Z-1,1,1,4,4,4-hexafluoro-2-butene (Z-HFO-1336mzz). In one embodiment according to the embodiment of this paragraph, the A component comprises Z-1,1,1,4,4,4-hexafluoro-2-butene (Z-HFO-1336mzz). According to one embodiment of this paragraph, the A component comprises Z-1,1,1,4,4,4-hexafluoro-2-butene (Z-HFO-1336mzz). According to one embodiment of this paragraph, the A component and the B component each comprise Z-1,1,1,4,4,4-hexafluoro-2-butene (Z-HFO-1336mzz).

In some embodiments of the method or the froth foam kit or the foamable composition or the foam produced by the method or using the froth foam kit or using the foamable composition, one or more isomers of butane and/or pentane is added to the A component or the B component or both. The pentane isomer may be n-pentane, isopentane, cyclopentane or a mixture of n-pentane and isopentane or a mixture of n-pentane and isopentane or a mixture of n-pentane, isopentane and cyclopentane or a mixture of isopentane and cyclopentane.

In some embodiments of the method or the froth foam kit or the foamable composition or the foam produced by the method or using the froth foam kit or using the foamable composition, methyl formate or water is added to the A component or the B component, or both.

In one embodiment of any of the preceding embodiments of the polyurethane froth foam kit, the A component comprises a blowing agent which comprises E-1,3,3,3-tetrafluoropropene (E-HFO-1234ze) and the B component may comprise a blowing agent which comprises E-HFO-1336mzz.

In some embodiments, the amount of E-HFO-1336mzz in the B component of the method or the froth foam kit as disclosed herein is between about 0% and about 20% by weight of the B component. The amount E-HFO-1336mzz in the B component can be for example, about 5% to about 20%, about 5% to about 15%, about 5% to about 10%, or about 10% to about 15%.

For clarity, if the amount of E-HFO-1336mzz in the B component of the method or of the froth foam kit is 0%, then the A component must comprise E-HFO-1336mzz. The amount of E-HFO-1336mzz in the A component is between about 0% and about 15% by weight of the A component. The amount E-HFO-1336mzz in the A component can be for example, about 5% to about 15%, or about 5% to about 10%.

In some embodiments, the amount of a co-blowing agent chosen from one or more carbon dioxide, nitrogen, or 1,1-difluoroethane (HFC-152a) in the B component of the method or of the froth foam kit is from about 0.1 to about 5%.

In one embodiment, the co-blowing agent is carbon dioxide and the amount of co-blowing agent in the B component of the method or of the froth foam kit is about 0.1 to about 1%.

In one embodiment, the co-blowing agent is nitrogen and the amount of co-blowing agent in the B component of the method or of the froth foam kit is about 0.1% to about 2%.

In one embodiment, the co-blowing agent is 1,1-difluoroethane and the amount of co-blowing agent in the B component of the method or of the froth foam kit is about 0.1% to about 2%.

In some embodiments, the A component of the method or of the froth foam kit comprises a co-blowing agent, and the co-blowing agent is carbon dioxide, nitrogen or a combination thereof.

In one embodiment, the A component of the method or of the froth foam kit comprises a co-blowing agent, and the co-blowing agent is carbon dioxide and the amount of co-blowing agent in the A component is about 0.1 to about 1%.

In one embodiment, the A component of the method or of the froth foam kit comprises a co-blowing agent, and the co-blowing agent is nitrogen and the amount of co-blowing agent in the A component is about 0.1% to about 2%.

When performing the method or when providing the froth foam kit as disclosed herein, the A component or the B component or both may comprise more than one co-blowing agent.

In one embodiment, one or more of Z-HFO-1336mzz, butane, pentane, methyl formate, and water are added to the A component of the method or of the froth foam kit.

In one embodiment, the B component of the method or of the froth foam kit comprises one or more of Z-HFO-1336mzz, butane, pentane, methyl formate, and water.

In one embodiment, the A component of the method or of the froth foam kit comprises Z-HFO-1336mzz and one or more isomers of butane. In one embodiment, the one or more isomers of butane comprises or is isobutane. In one embodiment, the A component of the method or of the froth foam kit comprises Z-HFO-1336mzz and one or more isomers of pentane. In one embodiment, the one or more isomers of pentane comprises or is cyclopentane. In one embodiment, the A component of the method or of the froth foam kit comprises Z-HFO-1336mzz and methyl formate. In one embodiment, the A component of the method or of the froth foam kit comprises Z-HFO-1336mzz and water.

In one embodiment, the B component of the method or of the froth foam kit comprises Z-HFO-1336mzz and one or more isomers of butane. In one embodiment, the one or more isomers of butane comprises or is isobutane. In one embodiment, the B component of the method or of the froth foam kit comprises Z-HFO-1336mzz and one or more isomers of pentane. In one embodiment, the one or more isomers of pentane comprises or is cyclopentane. In one embodiment, the B component of the method or of the froth foam kit comprises Z-HFO-1336mzz and methyl formate. In one embodiment, the B component of the method or of the froth foam kit comprises Z-HFO-1336mzz and water.

In one embodiment of the present method, the A component of the method or of the froth foam kit comprises E-1,3,3,3-tetrafluoropropene (E-HFO-1234ze) and the B component comprises HFO-1336mzz-E. In this embodiment, one option is that no catalyst is present in the A component. One option is that no water is present in the A component of the method or of the froth foam kit. When no catalyst and no water is present in the A component, the stability of the A component comprising E-HFO-1234ze is improved, as catalyst and/or water may cause the A component comprising E-HFO-1234ze to degrade.

The amount of E-HFO-1234ze in the A component of the method or of the froth foam kit is between about 0% and about 15% by weight of the A component. The amount E-HFO-1234ze in the A component of the method or of the froth foam kit can be for example, about 5% to about 15%, or about 5% to about 10%.

In one embodiment of the present method or of the present froth foam kit, when the B component comprises E-HFO-1234ze, the B component further comprises CO₂. In one embodiment of this present method or froth foam kit, when the B component comprises E-HFO-1234ze, there is no CO₂ in the B component.

In some of the foregoing methods or froth foam kits, the A component or the B component comprises Z-1,1,1,4,4,4-hexafluoro-2-butene (Z-HFO-1336mzz). When the A component or the B component comprises Z-HFO-1336mzz, the amount of Z-HFO-1336mzz is greater than 0% to about 20%, such as from 1% to about 15%, for example, from 1% to 10%, where percents are based on the total weight of the A component or the B component. In one embodiment the amount of Z-HFO-1336mzz in the B component is about 1% to about 5%, based on the total weight of the B component.

In any of the foregoing methods or froth foam kits, one or more isomers of or butane or pentane is added to the A component or the B component. In such methods or froth foam kits, the preferred butane isomer is isobutane. In such methods or froth foam kits, the pentane isomer may be chosen from one or more of n-pentane, isopentane and cyclopentane, preferably, cyclopentane. If butane or pentane is used, the amount of butane or pentane added is from 1%-10%, based on the total weight of the A component or the B component.

In one embodiment of the method or froth foam kit, methyl formate or water is added to the A component or the B component, or both.

When water is added to the A component of the method or froth foam kit or the B component of the method or froth foam kit, the amount of water added is greater than 0% to about 5%, such as from 0.1% to about 3%, for example, from 0.2 to 5%, where percents are based on the total weight of the A component or the B component. In one embodiment the amount of water added to the B component is about 1% to about 2%, based on the total weight of the B component.

When methyl formate is added to the A component of the method or froth foam kit or the B component of the method or froth foam kit, the amount of added methyl formate is from greater than 0% up to 4.5%, for example from 0.5% to 3%, where percents are based on the total weight of the A component or the B component.

The combination of the A component and the B component is referred to herein as a “foamable composition”. The foamable composition comprises: (a) a blowing agent comprising E-1,1,1,4,4,4-hexafluoro-2-butene (E-HFO-1336mzz); (b) one or more of a co-blowing agent chosen from carbon dioxide, nitrogen, or 1,1-difluoroethane (HFC-152a); (c) an isocyanate; (d) a polyol; (e) a catalyst; and (f) a surfactant.

One embodiment of this disclosure is a foamable composition, which includes the A component and the B component as disclosed hereinabove for the method and the froth foam kit. In one embodiment, the foamable composition comprises E-HFO-1234ze.

In some embodiments of the foamable composition of this disclosure, the total amount of blowing agent comprising E-HFO-1336mzz and the one or more of a co-blowing agent chosen from carbon dioxide, nitrogen, or 1,1-difluoroethane comprises between about 5% and about 15% by weight of the foamable composition, such as between about 10% and about 15% by weight of the foamable composition.

In one embodiment, the foamable composition comprises Z-1,1,1,4,4,4-hexafluoro-2-butene (Z-HFO-1336mzz). The total amount of blowing agent comprising E-HFO-1336mzz, Z-HFO-1336mzz and the one or more of a co-blowing agent chosen from carbon dioxide, nitrogen, or 1,1-difluoroethane comprises between about 5% and about 15% by weight of the foamable composition, such as between about 10% and about 15% by weight of the foamable composition.

In some embodiments, the foamable composition comprises one or more isomers of butane and/or pentane. Butane isomer is preferably isobutane. Isomers of pentane include n-pentane, isopentane and cyclopentane. The pentane isomer may be n-pentane, isopentane, cyclopentane or a mixture of n-pentane and isopentane or a mixture of n-pentane and isopentane or a mixture of n-pentane, isopentane and cyclopentane or a mixture of isopentane and cyclopentane.

In some embodiments, the foamable composition comprises methyl formate or water. The foamable composition may comprise Z-HFO-1336mzz and methyl formate. The foamable composition may comprise Z-HFO-1336mzz and water.

In the present method, the isocyanate can be any suitable isocyanate. A suitable isocyanate has at least two isocyanate groups per one molecule. Suitable isocyanates include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3-cyclohexylene diisocyanate, 1,4-cyclohexylene diisocyanate, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmethane diisocyanate, isomers thereof, and/or combinations of two or more of these.

For example, the isocyanate may have an NCO content of 25% to 35%, a functionality of 2.5-3.0 and a viscosity of 150-220 cP.

In certain embodiments, the isocyanate-reactive compound is a polyol.

In some embodiments, the polyol is a polyester polyol. Suitable polyester polyols include those prepared by reacting a carboxylic acid and/or a derivative thereof or a polycarboxylic anhydride with a polyhydric alcohol. The polycarboxylic acids can be any of the known aliphatic, cycloaliphatic, aromatic, and/or heterocyclic polycarboxylic acids and can be substituted (e.g., with halogen atoms) and/or unsaturated. Examples of suitable polycarboxylic acids and anhydrides include oxalic acid, malonic acid, glutaric acid, pimelic acid, succinic acid, adipic acid, suberic acid, azelaic acid, sebacic acid, phthalic acid, isophthalic acid, terephthalic acid, trimellitic acid, trimellitic acid anhydride, pyromellitic dianhydride, phthalic acid anhydride, tetrahydrophthalic acid anhydride, hexahydrophthalic acid anhydride, endomethylene tetrahydrophthalic acid anhydride, glutaric acid anhydride acid, maleic acid, maleic acid anhydride, fumaric acid, and dimeric and trimeric fatty acids, such as those of oleic acid which may be in admixture with monomeric fatty acids. Simple esters of polycarboxylic acids can also be used, such as terephthalic acid dimethylester, terephthalic acid bisglycol and extracts thereof. The polyhydric alcohols suitable for the preparation of polyester polyols can be aliphatic, cycloaliphatic, aromatic, and/or heterocyclic. The polyhydric alcohols optionally can include substituents which are inert in the reaction, for example, chlorine and bromine substituents, and/or may be unsaturated. Suitable amino alcohols, such as monoethanolamine, diethanolamine or the like can also be used. Examples of suitable polyhydric alcohols include ethylene glycol, propylene glycol, polyoxyalkylene glycols (such as diethylene glycol, polyethylene glycol, dipropylene glycol and polypropylene glycol), glycerol, and trimethylolpropane.

Other suitable polyester polyols include, but are not limited to, aromatic polyester polyols, e.g., those made by transesterifying polyethylene terephthalate (PET) scrap with a glycol such as diethylene glycol, or made by reacting phthalic anhydride with a glycol. The resulting polyester polyols can be reacted further with ethylene and/or propylene oxide to form an extended polyester polyol containing additional internal alkyleneoxy groups.

In some embodiments, the polyester polyol has an average molecular weight of from about 400 g/mol to about 500 g/mol, such as from about 450 g/mol to about 475 g/mol. In some embodiments, the polyester polyol is an aromatic polyester polyol with an average hydroxyl number of from about 200 to about 325, such as from about 200 mg KOH/g to about 300 mg KOH/g, or from about 235 to about 265, or about 230 to about 250, or about 295 to about 315 mg KOH/g.

Exemplary polyester polyols that are commercially available include the polyester polyols Stepanpol® PS-2352 (Stepan Company, Chicago, IL), Stepanpol® PS-2502A (Stepan Company, Chicago, IL), Stepanpol® PS-2412 (Stepan Company, Chicago, IL), Stepanpol® PS-2520 (Stepan Company, Chicago, IL), Stepanpol® PS-3021 (Stepan Company, Chicago, IL), Stepanpol® PS-3024 (Stepan Company, Chicago, IL), Terol® 256 (Huntsman, The Woodlands, TX), and Terol® 925 (Huntsman, The Woodlands, TX), Terol® 250 (Huntsman, The Woodlands, TX), Terol® 305 (Huntsman, The Woodlands, TX), Terol®563 (Huntsman, The Woodlands, TX), Terol® 649 (Huntsman, The Woodlands, TX), Terol® 1465 (Huntsman, The Woodlands, TX), Isoexter® TB-305 (COIM, West Deptford, NJ), Isoexter® TB-306 (COIM, West Deptford, NJ), Terate® HT5510 (Invista), Terate® 5232 (Invista), Terate® 5100 (Invista), Terate® 5150 (Invista), Terate® 5170 (Invista), Carpol® PES-240 (Carpenter Co., Richmond, VA), Carpol® PES-265 (Carpenter Co., Richmond, VA), Carpol® PES-305 (Carpenter Co., Richmond, VA), Carpol® PES-295 (Carpenter Co., Richmond, VA),

In some embodiments, the polyol comprises one or more polyether polyols. Examples of suitable polyether polyols include, but are not limited to, polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16 or 3 to 8 hydroxyl groups as present, for example, in glycerol, pentaerythritol and carbohydrates such as sorbitol, glucose, sucrose and the like polyhydroxy compounds. Suitable polyether polyols can also include aliphatic or aromatic amine-based polyols. Exemplary polyether polyols that are commercially available include the polyether polyols JEFFOL® PPG-400 (Huntsman, The Woodlands, TX), JEFFOL® PPG-1000 (Huntsman, The Woodlands, TX), JEFFOL® FX31-240 (Huntsman, The Woodlands, TX), JEFFOL® G31-28 (Huntsman, The Woodlands, TX), JEFFOL® R-425X (Huntsman, The Woodlands, TX), JEFFOL® R-470X (Huntsman, The Woodlands, TX), JEFFOL® S-490 (Huntsman, The Woodlands, TX), JEFFOL©SG-360 (Huntsman, The Woodlands, TX), JEFFOL® SG-522 (Huntsman, The Woodlands, TX), Carpol® PGP-400 (Carpenter Co., Richmond, VA), Carpol® PGP-1000 (Carpenter Co., Richmond, VA), Carpol® GP-700 (Carpenter Co., Richmond, VA), Carpol® GP-6015 (Carpenter Co., Richmond, VA), Carpol® MX-425 (Carpenter Co., Richmond, VA), Carpol® MX-470 (Carpenter Co., Richmond, VA), Carpol® GSP-355 (Carpenter Co., Richmond, VA), Carpol® GSP-520 (Carpenter Co., Richmond, VA), Carpol® SP-477 (Carpenter Co., Richmond, VA), VORANOL® 220-260 (Dow Chemical, Midland, MI), VORANOL® 220-110 (Dow Chemical, Midland, MI), VORANOL® 230-238 (Dow Chemical, Midland, MI), VORANOL® 232-027 (Dow Chemical, Midland, MI), VORANOL® 470 (Dow Chemical, Midland, MI), VORANOL® 360 (Dow Chemical, Midland, MI), VORANOL® 520 (Dow Chemical, Midland, MI), VORANOL® 391 (Dow Chemical, Midland, MI), Pluracol® P410R (BASF, Lemförde, Germany), Pluracol® P1010 (BASF, Lemförde, Germany), Pluracol® GP730 (BASF, Lemförde, Germany), Pluracol® 220 (BASF, Lemförde, Germany), Lupranol® 3422 (BASF, Lemförde, Germany), Pluracol® SG-360 (BASF, Lemförde, Germany), Pluracol® 824 (BASF, Lemförde, Germany), Pluracol® 735 (BASF, Lemförde, Germany), ARCOL® PPG-425 (Covestro, Leverkusen, Germany), ARCOL® 1000 (Covestro, Leverkusen, Germany), ARCOL® LHT-240 (Covestro, Leverkusen, Germany), MULTRANOL® 9139 (Covestro, Leverkusen, Germany), MULTRANOL® 3901 (Covestro, Leverkusen, Germany), MULTRANOL® 4034 (Covestro, Leverkusen, Germany), Poly-G©20-265 (Monument Chemical, Indianapolis, IN), Poly-G© 20-112 (Monument Chemical, Indianapolis, IN), Poly-G© 30-240 (Monument Chemical, Indianapolis, IN), Poly-G® 85-29 (Monument Chemical, Indianapolis, IN), Poly-G® 73-490 (Monument Chemical, Indianapolis, IN), Poly-G® 74-376 (Monument Chemical, Indianapolis, IN), and Poly-G© 74-532.

In some embodiments, the polyether polyol is a medium functional polyether polyol. For example, the polyether polyol has a functionality of about four. In some embodiments, the polyether polyol is sucrose/glycerin initiated. In some embodiments, the polyether polyol is a Mannich-based polyether polyol. As used herein, the term “Mannich-based polyol” refers to an aromatic polyol obtained by alkoxylation with propylene oxide and/or ethylene oxide of the Mannich bases obtained by classical Mannich reaction between phenols (e.g., phenol, p-nonylphenol), formaldehyde and alkanolamines (diethanolamine, diisopropanolamine, monoethanolamine, monoisopropanolamine, etc.). Exemplary commercially available polyether polyols include Voranol® 490 (Dow Chemical, Midland, MI), Carpol® MX-425 (Carpenter Co., Richmond, VA), and Carpol® MX-470 (Carpenter Co., Richmond, VA).

In some embodiments, the polyol comprises a combination of polyester polyol and polyether polyol.

In some embodiments, one or more additives can be included in the B component described herein. For example, the B component can further comprise one or more additives that include, but are not limited to, catalysts, surfactants, flame retardants, stabilizers, preservatives, chain extenders, cross-linkers, water, colorants, antioxidants, reinforcing agents, fillers, antistatic agents, nucleating agents, smoke suppressants, and pigments.

In some embodiments, the B component comprises at least one catalyst, at least one surfactant, water, at least one flame retardant agent, and at least one nucleating agent.

Suitable urethane catalyst can be used, including amine-based compounds, such as tertiary amine compounds, for example, dimethylethanolamine and bis(2-dimethylamino ethyl) ether, and organometallic compounds. Such catalysts are used in an amount which increases the rate of reaction of the polyisocyanate. By way of example, typical amounts of catalyst used are about 0.1 to about 5 parts of catalyst per 100 parts by weight of polyol. In some embodiments, the foamable compositions comprise a gel catalyst, such as a non-nucleophilic gel catalyst. In some embodiments, the foamable compositions comprise a blow catalyst. In some embodiments, the foamable compositions comprise a metal catalyst. In some embodiments, the foamable composition comprises a metal catalyst and an amine catalyst.

Exemplary catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine salts, may also optionally be employed herein. Such catalysts are used in an amount which measurably increases the rate of reaction of the polyisocyanate. Typical amounts of catalysts are about 0.1% to about 5% by weight based on the total weight of all foaming ingredients. Non-limiting examples of catalysts include POLYCAT® 8, N,N-dimethylcyclohexylamine from Evonik Industries, POLYCAT® 5, pentamethyldiethylenetriamine from Evonik Industries, and CURITHANE® 52, 2-methyl(n-methyl amino b-sodium acetate nonyl phenol) from Evonik Industries, POLYCAT® 30 (Evonik Industries), POLYCAT® 36 (Evonik Industries), POLYCAT® 46 (Evonik Industries), POLYCAT® 77 (Evonik Industries), POLYCAT® 9 (Evonik Industries), Dabco® 2039 (Evonik Industries), Dabco® K15 (Evonik Industries), Dabco® 204 (Evonik Industries), Dabco® 2040 (Evonik Industries), Dabco® BL-19 (Evonik Industries), Dabco® BL-17 (Evonik Industries), Dabco® T (Evonik Industries), Dabco® T-125 (Evonik Industries), Dabco® K-15 (Evonik Industries), Dabco® TMR (Evonik Industries), Dabco® TMR-2 (Evonik Industries), Dabco® TMR-3 (Evonik Industries), Dabco® TMR-30 (Evonik Industries), Bicat® 8210 (The Shepard Chemical Company, Cincinnati, OH), Bicat® 8840 (The Shepard Chemical Company, Cincinnati, OH), Bicat® 8842 (The Shepard Chemical Company, Cincinnati, OH), K-Kat® XK 651 (King Industries, Norwalk, CT), K-Kat© 614 (King Industries, Norwalk, CT), K-Kat® 672 (King Industries, Norwalk, CT), K-Kat® 604 (King Industries, Norwalk, CT), Niax® UL1 (Momentive Performance Materials Inc., Waterford, NY), Niax® UL22, Niax® UL1 (Momentive Performance Materials Inc., Waterford, NY, Jeffamine® D-230 (Huntsman, The Woodlands, TX), Jeffamine® T403 (Huntsman, The Woodlands, TX), Jeffamine® D2000 (Huntsman, The Woodlands, TX), Jeffamine® T5000 (Huntsman, The Woodlands, TX), Jeffcat® PMDETA (Huntsman, The Woodlands, TX), Jeffcat® DMCHA (Huntsman, The Woodlands, TX), Jeffamine® ZF20 (Huntsman, The Woodlands, TX), Jeffamine® ZF54 (Huntsman, The Woodlands, TX), tin, dibutyltin mercaptide, potassium octoate, potassium acetate, bismuth, bismuth carboxylate mixtures, and the like.

In some embodiments, the foamable composition comprises a surfactant. Suitable surfactants can comprise a liquid or solid organosilicone compound. Other surfactants include polyethylene glycol ethers of long chain alcohols, tertiary amine or alkanolamine salts of long chain alkyl acid sulfate esters, alkyl sulfonic esters, and alkyl arylsulfonic acids. In some embodiments, the surfactant is a silicone surfactant. In some embodiments, the surfactant is a silicone polyether surfactant. In some embodiments, the surfactant is Dabco® DC5585.

In some embodiments, the B component comprises a flame retardant agent. Useful flame retardant agents include, but are not limited to, tris(2-chloroethyl) phosphate, tris(2-chloropropyl) phosphate, tris(1-chloro-2-propyl) phosphate (TCPP), tris(2,3-dibromopropyl) phosphate, tris(1,3-dichloropropyl) phosphate, diammonium phosphate, halogenated aromatic compounds, antimony oxide, aluminum trihydrate, polyvinyl chloride, bromine-containing diester/ether diols of tetrabromophthalic anhydride, such as a mixed ester of tetrabromophthalic anhydride with diethylene glycol and propylene glycol. Exemplary commercially available flame retardant agents include Saytex® RB-79, a reactive bromine-containing diester/ether diol of tetrabromophthalic anhydride (Albemarle Corporation, Baton Rouge, LA). In some embodiments, the flame retardant agent is tris(1-chloro-2-propyl) phosphate (TCPP).

In some embodiments, the B component comprises a nucleating agent. Nucleating agents serve primarily to increase cell count and decrease cell size in the foam, and can be used in an amount of about 0.1 to about 10 parts by weight per 100 parts by weight of the resin. Typical nucleating agents comprise at least one member selected from the group consisting of talc, sodium bicarbonate-citric acid mixtures, calcium silicate, and carbon dioxide, among others. In some embodiments, the foamable composition does not comprise a nucleating agent. In some embodiments, the processes provided herein are performed in the absence of a nucleating agent. Exemplary nucleating agents include, but art not limited to, talc, sodium bicarbonate-citric acid mixtures, calcium silicate, carbon dioxide, and the like.

In some embodiments, the B component comprises E-HFO-1336mzz, at least one polyol, at least one catalyst, at least one surfactant, at least one flame retardant agent, and at least one nucleating agent described herein.

### EXAMPLES

### Materials

Opteon™ 1100 (Z-1,1,1,4,4,4-hexafluoro-2-butene, Z-HFO-1336mzz) and Opteon™ 1150 (E-1,1,1,4,4,4-hexafluoro-2-butene, E-HFO-1336mzz) foam blowing agents are available from The Chemours Company FC, LLC, Wilmington, DE. (Note for convenience, Opteon™ 1100 may be referred to herein as “1100”, and Opteon™ 1150 may be referred to herein as “1150”.) PS 2352 is Stepanpol PS 2352 polyester polyol, available from Stepan Company, Northfield, IL. Pluracol® SG-360 polyol is available from BASF Corporation, Wyandotte, MI. Carpol® P-700 polyether polyol is available from Carpenter Co., Richmond, VA. TCPP is tris (1-chloro-2-propyl) phosphate. PHT4-DIOL™ flame retardant is available from LANXESS Solutions US Inc., Pittsburgh, PA. DC 193 silicone surfactant is commercially available. LK-443 surfactant is available from Evonik Industries. Catalysts, including amine catalysts and isocyanurate catalysts are available from Evonik Industries. Polymeric MDI (isocyanate) is available from Dow Chemical Company, Midland, MI. DEG is diethylene glycol, commercially available.

### Example 1. LPSPF Test Formula 1

### Hand Mixed Foams

Opteon™ blowing agents were pre-mixed by hand mixing into the isocyanate side to mimic the isocyanate can of a LPSPF kit. The blowing agents used in the isocyanate were the same ratio of Opteon™ 1100 and 1150 but at half the percent loading of the resin percent loading. The two components were mixed at 4000 rpm with an arrow overhead mixer. Table 1 provides the resin formula and Table 2 provides the physical properties of the hand mixed foams. The hand mix shows that overwhelmingly, Opteon™ blowing agents exceed the desired R-value of 6 and meet the other desired physical properties, such density and closed cell content.

TABLE 1
LPSPF Kit Hand Mix - Test Formula 1

| | |
|---|---|
| Material | Percent |

B Component

| | |
|---|---|
| PS 2352 | 18.50% |
| SG 360 | 23.00% |
| GP 700 | 4.00% |
| TCPP | 27.00% |
| PHT4 DIOL | 7.00% |
| DC193 | 1.00% |
| LK443 | 1.00% |
| Polycat 5 | 1.75% |
| Dabco K15 | 1.50% |
| Polycat 9 | 0.75% |
| Water | 1.50% |
| Opteon ™ 1100 | 0.00% |
| Opteon ™ 1150 | 12.48% |
| CO₂ | 0.52% |

A Component

| | |
|---|---|
| POLYMERIC MDI | 93.5% |
| CO₂ | 0.3% |
| Opteon 1150 | 6.2% |

TABLE 2
Test Formula 1 Properties

| | | | | Compressive | | |
|---|---|---|---|---|---|---|
| | | | | Strength | | |
| | | Density | | (Max and | Initial k- | R- |
| Formula | Blowing Agents | (pcf) | CC % | Break) In PSI | factor | value |
| Hand | Test Formula 1 | 1.97 | 92.4 | 19.3 | 0.1410 | 7.09 |
| Mix | | | | 12.2 | | |
| Hand | 1100/1150/Water | 1.93 | 93.8 | 21.7 | 0.1412 | 7.08 |
| Mix | 6.5%/6.5%/1.5% | | | 8.0 | | |

### Example 2. LPSPF Test Formula 2

### Shelf Life Test

Shelf life was assessed based on formation of carbonic acid. The theory is that carbonic acid is formed from reaction of Opteon™ 1150, carbon dioxide, and water. Carbonic acid, if formed, reacts with amine catalyst over time and hinders reactivity of a LPSPF kit.

A test cylinder, which was capable of holding pressure suitable (15 to 25 psi) for a LPSPF kit, was designed to assess shelf life in an accelerated aging test. Four test cylinders were loaded with the formula set forth in Table 3 and rolled for one hour to ensure even mixing. Three cylinders were placed in an oven at 50° C. to age. The first cylinder was then opened and pour into a beaker and hand mixed with isocyanate immediately to get the initial reactivity. The other cylinders followed a similar procedure for measuring reactivity at one, two, and three weeks of aging. If carbonic acid were to form and hinder the catalysts, it would form quickly in a heated environment.

TABLE 3
Shelf Life - Test Formula 2

| | |
|---|---|
| MATERIAL | % |

B Component

| | |
|---|---|
| PS 2352 | 19.00% |
| DEG | 4.00% |
| SG 360 | 23.00% |
| GP 700 | 5.00% |
| PM 301 | 2.50% |
| TCPP | 27.00% |
| DC193 | 1.00% |
| Polycat 5 | 1.75% |
| Dabco K15 | 1.50% |
| Polycat 9 | 0.75% |
| Water | 1.50% |
| Opteon ™ 1100 | 12.48% |
| CO₂ | 0.52% |

A Component

| | |
|---|---|
| POLYMERIC MDI | 93.5% |
| CO₂ | 0.3% |
| Opteon ™ 1150 | 6.2% |

TABLE 4
Testing for Carbonic Acid Generation via Reactivity Changes

| | A-side | B-side | | | | |
|---|---|---|---|---|---|---|
| | Temperature | Temperature | Cream | Gel | Rise | Tack |
| | (° C.) | (° C.) | (seconds) | (seconds) | (seconds) | (seconds) |
| Initial | 18.2 | 20.0 | <1 | 16 | 15 | 36 |
| Week 1 | 19.4 | 21.2 | 2 | 16 | 22 | 36 |
| Week 2 | 16.1 | 20.1 | 2 | 17 | 21 | 35 |
| Week 3 | 17.3 | 20.4 | 2 | 20 | 24 | 39 |

The shelf life test showed no significant carbonic acid was generated since there was no impact on reactivity as illustrated by times for cream, gel, rise and tack.

### Sprayed Foams

The formula set forth in Table 3 (Test Formula 2) was used in sprays of LPSPF kits. The results are provided in Table 5.

TABLE 5
Physical Properties of Sprayed LPSPF Kits

| | CO₂ | | | | |
|---|---|---|---|---|---|
| Blowing Agent (BA) | Level | Dispensing | | | Closed |
| Combo | of BA | Ratio | R-value | Density | Cell |
| 1150/CO₂/Water | 4 | 1.57 | 5.61 | 2.53 | 83.1 |
| 12.48%/0.52%/1.5% | | | | | |
| 1150/CO₂/Water | 3 | 1.77 | 5.98 | 2.76 | 85.6 |
| 12.61%/0.39%/1.5% | | | | | |
| 1150/1100/CO₂/Water | 4 | 1.42 | 5.83 | 2.28 | 81.4 |
| 11.35%/1.26%/0.52%/1.5% | | | | | |
| 1150/1100/CO₂/Water | 3 | 1.35 | 5.97 | 2.23 | 80.6 |
| 11.35%/1.26%/0.39%/1.5% | | | | | |
| 1150/1100/CO₂/Water | 4 | 1.84 | 5.56 | 2.62 | 79.8 |
| 8.83%/3.78%/0.52%/1.5% | | | | | |
| 1150/1100/CO₂/Water | 3 | 1.18 | 5.34 | 1.98 | 83.9 |
| 8.83%/3.78%/0.39%/1.5% | | | | | |

### Example 3. LPSPF Test Formula 3

### Aging Test

Note: only the resin side of the LPSPF kits were aged. All isocyanate sides were made the day of the spray testing. The isocyanate sides were not aged due to the lack of reactivity that may affect the blowing agents, catalysts, or surfactants. The kits were filled with the blowing agents but not pressurized to 200 psi with nitrogen due to safety concerns. When it was time to test the kits, the resin kits were removed from the oven and allowed to cool to room temperature. Along with the isocyanate cans, the resin cans were pressurized with nitrogen to 200 psi. Separate cans were made for the 0-hour, 2-week, 4-week, and 6-week sprays. Tables 6-9 show properties for the formulation. (MF is methyl formate; tDCE is trans-dichloroethylene.)

TABLE 6
Dispensing of Sprayed LPSPF Kits vs Aging

| | 0 Hour | 2-week | 4-week | 6-week |
|---|---|---|---|---|
| | Dispensing | Dispensing | Dispensing | Dispensing |
| Blowing Agent Combo | Ratio | Ratio | Ratio | Ratio |
| 1150/MF/CO₂/Water | 1.24 | 0.94 | 1.10* | 1.11* |
| 8.83%/3.78%/0.39%/1.5% | | | | |
| 1150/1100/CO₂/Water | 1.35 | 1.00 | 1.16 | 1.30* |
| 11.35%/1.26%/0.39%/1.5% | | | | |
| 1150/1100/CO₂/Water | 1.18 | 0.77 | 1.02 | 1.06 |
| 8.83%/3.78%/0.39%/1.5% | | | | |
| 1150/tDCE/CO₂/Water | 1.70 | 1.17 | Clogged | 1.21 |
| 11.35%/1.26%/0.39%/1.5% | | | Line | |
| 1150/152a/CO₂/Water | 1.35 | 1.14 | 0.99 | 1.28 |
| 11.60%/1.01%/0.39%/1.5% | | | | |
| 1234ze/H₂O | 1.10 | 1.28* | DNS | DNS |
| 13.0%/1.5% | | | | |

*DNS denotes “did not spray”.

TABLE 7
Density of Sprayed LPSPF Kits vs Aging

| | 0 Hour | 2-week | 4-week | 6-week |
|---|---|---|---|---|
| Blowing Agent Combo | Density | Density | Density | Density |
| 1150/MF/CO₂/Water | 2.05 | 1.89 | DNF | DNF |
| 8.83%/3.78%/0.39%/1.5% | | | | |
| 1150/1100/CO₂/Water | 2.23 | 2.11 | 2.29 | DNF |
| 11.35%/1.26%/0.39%/1.5% | | | | |
| 1150/1100/CO₂/Water | 1.98 | 1.98 | 2.06 | 2.09 |
| 8.83%/3.78%/0.39%/1.5% | | | | |
| 1150/tDCE/CO₂/Water | 2.03 | 2.35 | Clogged | DNF |
| 11.35%/1.26%/0.39%/1.5% | | | Line | |
| 1150/152a/CO₂/Water | 2.40 | 2.23 | 1.98 | DNF |
| 11.60%/1.01%/0.39%/1.5% | | | | |
| 1234ze/H₂O | 1.87 | DNF | DNS | DNS |
| 13.0%/1.5% | | | | |

DNF denotes a sample that did not make a testable polyurethane foam sample.
DNS denotes “did not spray”.

TABLE 8
Closed Cell Content of Sprayed LPSPF Kits vs Aging

| | 0 Hour | 2-week |
|---|---|---|
| Blowing Agent Combo | Closed Cell | Closed Cell |
| 1150/MF/CO₂/Water | 51.0 | 11.2 |
| 8.83%/3.78%/0.39%/1.5% | | |
| 1150/1100/CO₂/Water | 80.6 | 75.2 |
| 11.35%/1.26%/0.39%/1.5% | | |
| 1150/1100/CO₂/Water | 83.9 | 64.7 |
| 8.83%/3.78%/0.39%/1.5% | | |
| 1150/tDCE/CO₂/Water | 74.1 | 75.2 |
| 11.35%/1.26%/0.39%/1.5% | | |
| 1150/152a/CO₂/Water | 80.2 | 70.6 |
| 11.60%/1.01%/0.39%/1.5% | | |
| 1234ze/H₂O | 15.5 | DNF |
| 13.0%/1.5% | | |

DNF denotes a sample that did not make a testable polyurethane foam sample

TABLE 9
R-Value (insulating factor) of LPSPF Kits vs Aging

| Blowing Agent Combo | 0 Hour R | 2-week R |
|---|---|---|
| 1150/MF/CO₂/Water | 5.54 | 3.64 |
| 8.83%/3.78%/0.39%/1.5% | | |
| 1150/1100/CO₂/Water | 5.97 | 4.81 |
| 11.35%/1.26%/0.39%/1.5% | | |
| 1150/1100/CO₂/Water | 5.34 | 4.72 |
| 8.83%/3.78%/0.39%/1.5% | | |
| 1150/tDCE/CO₂/Water | 5.54 | 5.41 |
| 11.35%/1.26%/0.39%/1.5% | | |
| 1150/152a/CO₂/Water | 5.82 | 5.17 |
| 11.60%/1.01%/0.39%/1.5% | | |
| 1234ze/H₂O | 3.94 | DNF |
| 13.0%/1.5% | | |

DNF denotes a sample that did not make a testable polyurethane foam sample.

The samples subjected to accelerated aging were tested for their free ion content via ion chromatography as provided in Table 10. For each sample, three grams of B-side was diluted with thirty milliliters of pure water; that mixture was allowed to stir overnight. It was then subjected to IC (ion chromatography) per ASTM 04327. The samples may have been further diluted to so that the results were within the calibration curve of the machine to ensure accuracy.

TABLE 10
Ion Chromatography (ppm) of LPSPF Kits vs Aging

| | | | 2- | | | 4- | 6- | |
|---|---|---|---|---|---|---|---|---|
| Blowing | 0-Hour | 0-Hour | week | 2-week | 4-week | Week | week | 6-week |
| Agents | F— | Cl— | F— | Cl— | F— | Cl— | F— | Cl— |
| Blank | <MDL | 28.57 | <MDL | 769.1 | 3.4 | 1101.4 | 2.82 | 1320.6 |
| 90/10 | <MDL | 71.94 | 14.01 | 481.58 | 17.39 | 863.9 | 34.99 | 1153.45 |
| 1150/1100 | | | | | | | | |
| 70/30 | <MDL | 71.21 | 35.75 | 395.7 | 17.87 | 864.2 | 18.33 | 1173.2 |
| 1150/1100 | | | | | | | | |
| 70/30 1150 | UD | 52.62 | 13.34 | 475.33 | 32.76 | 586.2 | 8.89 | 740.4 |
| MF | | | | | | | | |
| 92/8 | <MDL | 57.7 | <MDL | 533.5 | 25.58 | 969.35 | 27.3 | 1325.1 |
| 1150/152a | | | | | | | | |
| 90/10 | <MDL | 55.7 | <MDL | 477.9 | 18.8 | 915.71 | 23.1 | 1255.8 |
| 1150/tDCE | | | | | | | | |
| 1234ze | 325.9 | 69.74 | 12560.5 | 579.5 | 13134.4 | 954.2 | 14549 | 1069.7 |
| Pure 1150 | <MDL | 67.1 | <MDL | 523.6 | <MDL | 1152.8 | 22.4 | 1520.3 |
| 1150/CO₂ | <MDL | 60.5 | <MDL | 486.9 | <MDL | 1019.7 | 11.05 | 1474.8 |

<MDL denotes a sample that less than the minimum detection limit
Minimum detection for Fluoride anion is 0.2 ppm (parts per million)
Minimum detection for Chloride anion is 0.3 ppm

The free fluorine and chlorine anions in the B-sides are directly related to the breakdown of the blowing agents and the TCPP, in each formulation. As seen in the “Blank” sample with no blowing agent present, there is significant levels of chloride anion generated over the course of the accelerated aging.

Opteon™ based formulations are stable in the resin and common catalysts have little to no impact on these formulations.

E-1234ze-containing formulations were found to be not as stable as E-HFO-1336mzz-containing formulations in the presence of catalysts and increased chloride levels.

TABLE 11
Reactivity (seconds) of LPSPF Kits vs Aging

| Blowing Agents | Initial Gel | Initial Tack | 2-week Gel | 2-week Tack |
|---|---|---|---|---|
| 90/10 1150/1100 | 43 | 65 | x | x |
| 70/30 1150/1100 | 20 | 30 | x | x |
| 70/30 | 21 | 42 | x | x |
| 1150 MF | | | | |
| 92/8 1150/152a | 22 | 44 | 20 | 31 |
| 90/10 1150/tDCE | 23 | 40 | 22 | 32 |
| 1234ze | <15 | 24 | 180+ | 240+ |

x denotes measurement not taken.

As shown in the Examples, LPSPF formulations containing E-HFO-1336mzz have long shelf life when used in the presence of traditional polyols, catalysts, surfactants, and water levels in LPSPF kits. Such formulations also provided (good properties—comment on dispensing ratio, R-value, density, closed cell, etc.)

1. A method for the generation of a foam comprising:
(a) preparing an A component, which comprises an isocyanate;
(b) preparing a B component, which comprises an isocyanate-reactive compound, and
(c) generating a foam by mixing the A component and the B component at a low pressure;
wherein the A component or the B component or both further comprise a blowing agent comprising E-1,1,1,4,4,4-hexafluoro-2-butene (E-HFO-1336mzz) and one or more of a co-blowing agent chosen from carbon dioxide, nitrogen, or 1,1-difluoroethane (HFC-152a);
and wherein the low pressure is at least about 50 psi and up to about 500 psi (at least about 0.34 up to about 3.4 MPa).

2. The method of claim 1 wherein the A component comprises E-1,3,3,3-tetrafluoropropene (E-HFO-1234ze) and the B component comprises E-HFO-1336mzz.

3. The method of claim 1 wherein Z-1,1,1,4,4,4-hexafluoro-2-butene (Z-HFO-1336mzz) is added to the A component or the B component or both.

4-6. (canceled)

7. The method of claim 2 wherein the A component and the B component are provided in separate pressurized cylinders and the amount of co-blowing agent added to each cylinder is sufficient to equalize pressure in both cylinders.

8. The method of claim 3, wherein prior to dispensing, one or both cylinders are pressurized with a co-blowing agent, to achieve a pressure of at least 50 psi (0.34 MPa).

9. (canceled)

10. The method of claim 1 wherein methyl formate or water is added to the A component or the B component or both.

11-16. (canceled)

17. The method of claim 1 wherein the low pressure is from about 100 psi and up to about 400 psi (from about 0.69 MPa and up to about 2.76 MPa).

18. (canceled)

19. The method of claim 1 wherein the amount E-HFO-1336mzz in the B component is about 5% to about 20%, or about 5% to about 15%, or about 5% to about 10%, or about 10% to about 15% by weight of the B component.

20. The method of claim 1 wherein the amount E-HFO-1336mzz in the A component is between about 0% and about 15% by weight of the A component, or about 5% to about 20%, or about 5% to about 15%, or about 5% to about 10%, or about 10% to about 15% by weight of the A component.

21. The method of claim 1 wherein the amount the amount of co-blowing agent in the B component is about 0.1% to about 2%.

22-33. (canceled)

34. A polyurethane froth foam kit comprising:
(a) a cylinder comprising an A component, which comprises an isocyanate;
(b) a cylinder comprising a B component, which comprises an isocyanate-reactive compound;
(c) a low pressure mixer having a mixing chamber and a spray nozzle;
wherein E-1,1,1,4,4,4-hexafluoro-2-butene (E-HFO-1336mzz) and one or more of a co-blowing agent chosen from carbon dioxide, nitrogen, or 1,1-difluoroethane (HFC-152a) are added to the A component, the B component, or both; and
wherein the A component and the B component are provided in separate pressurized cylinders.

35-39. (canceled)

40. A foamable composition comprising: (a) a blowing agent comprising E-1,1,1,4,4,4-hexafluoro-2-butene (E-HFO-1336mzz); (b) one or more of a co-blowing agent chosen from carbon dioxide, nitrogen, or 1,1-difluoroethane (HFC-152a); (c) an isocyanate; (d) a polyol; (e) a catalyst; and (f) a surfactant.

41. The foamable composition of claim 40 wherein the composition comprises E-HFO-1234ze.

42. The foamable composition of claim 40, wherein the total amount of blowing agent comprising E-HFO-1336mzz and the one or more of a co-blowing agent chosen from carbon dioxide, nitrogen, or 1,1-difluoroethane comprises between about 5% and about 15% by weight of the foamable composition.

43. (canceled)

44. The foamable composition of claim 40, further comprising Z-HFO-1336mzz.

45-48. (canceled)
